(19) United States
(12) Patent Application Publication
(10) Pub. No.: US 2017/0245160 A1
(43) Pub. Date: Aug. 24, 2017

(54) A METHOD FOR OPERATING A WIRELESS NETWORK, A WIRELESS NETWORK AND A BASE STATION

(71) Applicant: NEC Europe Ltd., Heidelberg (DE)

(72) Inventors: Peter Rost, Heidelberg (DE); Athul Prasad, Helsinki (FI)

(21) Appl. No.: 15/313,976

(22) PCT Filed: May 28, 2014
(86) PCT No.: PCT/EP2014/061148

§ 371 Date: Nov. 25, 2016

(51) Int. Cl. H04W 16/24; H04W 36/06; H04L 5/14

(52) U.S. Cl. CPC H04W 16/24; H04L 5/14; H04W 36/06; H04W 88/08

(57) ABSTRACT

A method for operating a wireless network, wherein a base station is provided for data communication in uplink (UL) and downlink (DL) directions with at least one mobile device, includes operating the base station in a full duplex data communication mode during communication with the at least one mobile device.

### CROSS REFERENCE TO RELATED APPLICATIONS

This application is a U.S. National Stage Application under 35 U.S.C. §371 of International Application No. PCT/EP2014/061148 filed on May 28, 2014. The International Application was published in English on Dec. 3, 2015 as WO 2015/180773 A1 under PCT Article 21(2).

### FIELD

The present invention relates to a method for operating a wireless network, wherein a base station is provided for data communication in uplink (UL) and downlink (DL) directions with at least one mobile device. Further, the present invention relates to a wireless network, wherein a base station is provided for data communication in uplink (UL) and downlink (DL) directions with at least one mobile device. Further, the present invention relates to a base station, wherein the base station is provided for data communication in uplink (UL) and downlink (DL) directions with at least one mobile device.

### BACKGROUND

The following is a table of abbreviations used for various terms herein:

| Abbreviations | |
|---|---|
| 3GPP | Third Generation Partnership Project |
| BS | Base Station |
| CGI | Cell Global Identity |
| CQI | Channel Quality Information |
| eNB | evolved Node B |
| E-UTRAN | Evolved Universal Terrestrial Radio |
| | Access Network |
| eICIC | enhanced Inter-Cell Interference |
| | Coordination |
| FDD | Frequency Division Duplexing |
| LTE | Long Term Evolution |
| MCS | Modulation and Coding Scheme |
| PCI | Physical Cell ID |
| SIB | System Information Block |
| TDD | Time Division Duplexing |
| UE | User Equipment |
| UL | Uplink |
| ULI | User Location Information |

Currently, wireless networks or wireless communication systems are defined for half duplex communications, where the base station or eNodeB (eNB) as well as the mobile devices or user equipment (UE) sends or receives data at one point of time. Here time could imply time-frequency resources or physical resource blocks in the context of a communication system.

Currently defined standards in LTE, see 3GPP TS 36.300, “Evolved Universal Terrestrial Radio Access (E-UTRA) and Evolved Universal Terrestrial Radio Access Network (E-UTRAN); Overall description; Stage 2”, are mainly applicable only for a system based on half duplex base stations. The frame structure that is defined, the way basic system information is broadcasted to the UE using system information blocks, SIBs, etc. will work only when uplink and downlink is split either in time (TDD) or frequency (FDD) domain. Consider scheduling of DL and UL resources as an example. Currently, the physical resource blocks over which UE can send and receive data are completely controlled by the eNB. By using a full duplex BS, uplink and downlink can be done simultaneously. This would require enhancements in the currently defined system for supporting such an operation, e.g. in terms of resource allocation. Also, when BS operates in full duplex mode, this would also lead to increased control channel interference conditions at the UE side, since the UE would still be operating in half duplex mode. The interference source at the UE for e.g. engaging in UL could be from the BS sending DL data using the same resources. It could also be from a neighboring UE engaged in UL, while receiving DL data from the BS. Currently defined eICIC techniques for mitigating interference are not designed for such intra-cell interference problems, since such scenarios were not envisioned while designing the system.

### SUMMARY

In an embodiment, the present invention provides a method for operating a wireless network, wherein a base station is provided for data communication in uplink (UL) and downlink (DL) directions with at least one mobile device. The method includes operating the base station in a full duplex data communication mode during communication with the at least one mobile device.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a conventional base station in the form of an eNB with three cells switching between DL and UL over time,

FIG. 2 shows a base station in full duplex mode and in transparent mode for the mobile device according to an embodiment of the invention and

FIG. 3 shows a base station in full duplex mode and in non-transparent mode for the mobile device according to an embodiment of the invention.

### DETAILED DESCRIPTION

Channel Quality Information (CQI) is currently estimated by the UE using specific resource blocks sent by the eNB specifically for such estimation. While using full duplex mode, UE might estimate the quality of the channel in such a manner that eNB might not be able to infer the reason or interference source. This is due to the fact that eNB might estimate the interference to be due to neighbor cells, when the source could be the same cell which is operating in full duplex mode.

Embodiments of the invention can improve and further develop a method for operating a wireless network, an according network, and a base station for allowing a very high degree of utilization of available resources within the network by simple means.

In an embodiment, a method is provided wherein a base station is operated in a full duplex data communication mode during communication with at least one mobile device.

In an embodiment, a wireless network is provided wherein a base station comprises means for being operated in a full duplex data communication mode during communication with at least one mobile device.

In an embodiment, a base station is provided that comprises means for being operated in a full duplex data communication mode during communication with the at least one mobile device.

According to the invention, is has been recognized that it is possible to provide a very high degree of utilization of available resources and high transmission data rates within a network by simply realizing an enhanced mode of operation of a base station. Concretely, the base station is operated in a full duplex data communication mode during communication with at least one mobile device. While the base station is enabled for full duplex data communication in the uplink and downlink direction, the at least one mobile device can remain in half duplex data communication, either sending or receiving data. This remaining of the mobile device in half duplex data communication can be realized due to the additional complexity and costs involved in developing such mobile device hardware. Also, with sufficient amount of diversity in terms of users in a base station cell, higher data rates are possible with the use of full duplex communication at the base station side alone.

Within a preferred embodiment and with regard to a very simple realization of a full duplex data communication mode the base station can comprise at least two different virtual half duplex cells. The definition of at least two different virtual half duplex cells provides a so called transparent mode for the mobile device, i.e. from the perspective of the mobile device. In other words, the transparency here is defined from a mobile device perspective, whether the mobile device is aware of the base station providing full duplex communication or not. In the transparent mode the mobile device is unaware of the fact that the base station is capable of supporting full duplex data communication.

Preferably, the two virtual half duplex cells can be realized or defined within one full duplex cell of the base station. All full duplex cells of the base station could be realized as containing two virtual half duplex cells.

In a simple way the two virtual half duplex cells can have different Physical Cell IDs (PCIs) but can have the same Cell Global Identity (CGI). From the perspective of the mobile device said two virtual half duplex cells are two separate cells with different PCIs. However, for a core network the two virtual half duplex cells are one cell with the same CGI.

Within a preferred embodiment the at least one mobile device or each mobile device can be allocated into or can be assigned to each virtual half duplex cell. Thus, a high degree of utilization of available resources within the network is possible.

Regarding a reliable allocation or assignment of the mobile device or the mobile devices to each virtual half duplex cell several mobile devices can be grouped using or basing on geographical location and/or a channel condition. This will provide an effective use of available resources.

For providing a simple and reliable communication between the mobile device and the base station within the claimed method the base station can send different signaling information or two different physical layer control channels and/or associated signaling information for the same physical full duplex cell to the at least one mobile device. Such information can comprise cell specific reference signals and/or a system information block.

For providing an effective method for operating the wireless network and for reducing control signaling a handover of the at least one mobile device between the virtual half duplex cells can be performed internally within the base station. With regard to a very effective performance a handover of the at least one mobile device between the virtual half duplex cells can be performed using X2 handover procedure.

For an effective utilization of available resources mitigation of interference between simultaneous operations is preferred. Within a preferred embodiment an enhanced Inter-Cell Interference Coordination (eICIC) mechanism can be applied for mitigating interference between simultaneous UL/DL operations of a cell or macro cell, i.e. between virtual half duplex cells.

For transparent mode, since frequent and fast handover would be required, accurate measurement configurations are important. Within a preferred embodiment the base station can send measurement configurations via Radio Resource Control (RRC) signaling to the at least one mobile device. This simplifies the provision of effective measurement configurations.

Within a further preferred embodiment a non-transparent mode of operation is provided, wherein the full duplex operation is provided in a non-transparent manner to the at least one mobile device, meaning that the mobile device is aware of the fact that there are full duplex transmissions from its serving base station or cell. Within such an embodiment it is preferred that each cell of the base station can provide both UL and DL in the same time or frequency resources or physical resource blocks.

This could provide the disadvantage that the mobile device could estimate the channel conditions inaccurately due to intra-cell interference from its own serving cell transmissions. For overcoming this problem the base station can configure a static resource or static resources which is or are used by the at least one mobile device for measuring a quality of a channel.

Within a preferred embodiment the static resource or static resources can be in half duplex mode. Within further preferred embodiments the static resource or static resources can be reserved physical resource blocks within a subframe.

For providing a very reliable and effective method for operating a wireless network information about reserved resource blocks within a subframe can be signaled to the at least one mobile device. Depending on individual situations the signaling can be performed, if at least one definable characteristic of the static resource or static resources varies over a defined time interval by a defined amount or threshold. Within an alternative preferred embodiment the signaling can be performed in a static manner using at least one system information block or using any other control information meant for the mobile devices or UEs.

Preferably, the non-transparent mode can be operated in using an intra-eNB, intra-cell carrier aggregation mechanism with simultaneous UL/DL modes assumed to be two different carriers from mobile device's perspective. Using full duplex base stations or eNBs, the same carrier can be used for UL and DL. This means that, in an FDD system with separate carriers for UL and DL like in conventional systems, the half-duplex mobile device or UE could be configured to view the system as one employing carrier aggregation technique, with UL and DL resources scheduled in different carriers, but with a common carrier for control channel signaling. Using such a mechanism, the system would emulate carrier aggregation from mobile device's or UE's perspective, but operating in a full duplex mode from an overall system perspective. The system will use one carrier for control signalling and then two configurations: a) carrier aggregation with carrier 1 for UL and carrier 2 for DL, and b) carrier aggregation with carrier 2 for UL and carrier 1 for DL.

For avoiding high interference on control channels due to simultaneous UL/DL operation almost blank subframe concept can be used.

Additionally or alternatively a power control technique can be used to mitigate interference. Identifying the interference source as well as estimating the accurate link quality excluding intra-cell interference is important for mitigating interference.

Within a preferred embodiment the base station can be an eNodeB (eNB).

Embodiments of the invention provide a method for providing full duplex data communication in a transparent manner to a mobile device or UE using virtual cell concepts whereby the mobile device or UE considers a full duplex cell as two virtual half duplex cells. Preferably, the full duplex base station sends two different physical layer control channels and associated signaling information such as system information blocks, etc., for the same physical cell.

Embodiments of the invention provide means for providing simultaneous UL/DL in a non-transparent manner by reusing the cell resources as well. The grouping here could essentially involve intelligent scheduling of resources to each mobile device or UE to minimize interference within the cell. This could preferably be done by configuring static resources which are in half duplex mode and this information can be signaled to the mobile device or UE so that it can measure these resources for estimating the channel conditions.

A handover optimization can be performed in transparent mode using multiple PCIs for the same cell, but using only one CGI, in order to hide such cells from the core network, for minimizing control and user plane signaling.

It is provided a method for operating a full duplex base station having half duplex user equipment or at least one mobile device within its coverage region. The operation comprises a full duplex base station or eNB as two different virtual cells each operating as half duplex base station or eNB from UE or mobile device perspective with different PCIs but having the same CGI, and allocating each mobile device or UE into each virtual cell. There can be used almost blank subframesstill including pilots or reference signalsto overcome intra-cell interference. But this could lead to a sub-optimal resource utilization due to the un-used blank subframes.

Alternatively, the operation can comprise the same base station or eNB as a single cell with unique CGI and PCI by having mechanisms such as pre-configured measurement resources for channel estimation. Further, carrier aggregation can be used to differentiate resources from the mobile device or UE perspective.

By means of the present invention higher spectral efficiency and therefore better utilization of available spectral resources can be provided. The present invention provides minimum impacts to mechanisms that are already defined in former systems and methods.

Embodiments of the invention comprise two ways of provisioning such a system which are called as transparent and non-transparent. The transparency here is defined from an end user or UE perspective, whether a UE is aware of the BS or eNB providing full duplex communication or not. In the transparent method, UE is unaware of the fact that eNB is capable of supporting full duplex communication. This could be possible by using two different, e.g., virtual, cell IDs at the eNB, with each “cell” providing half duplex communication to the UEs. This method would also require an efficient means to group the UEs, possibly using geographical location profiles or channel conditions to assign it to corresponding eNB cells. Such a mechanism would essentially mean that depending on cell ID assignment algorithm involved, there could be frequent handovers between the virtual cells. Since both “cells” share the same backhaul infrastructure, this operation could be done internally in an implementation specific manner or using X2 handover procedure with minimal involvement of the core network.

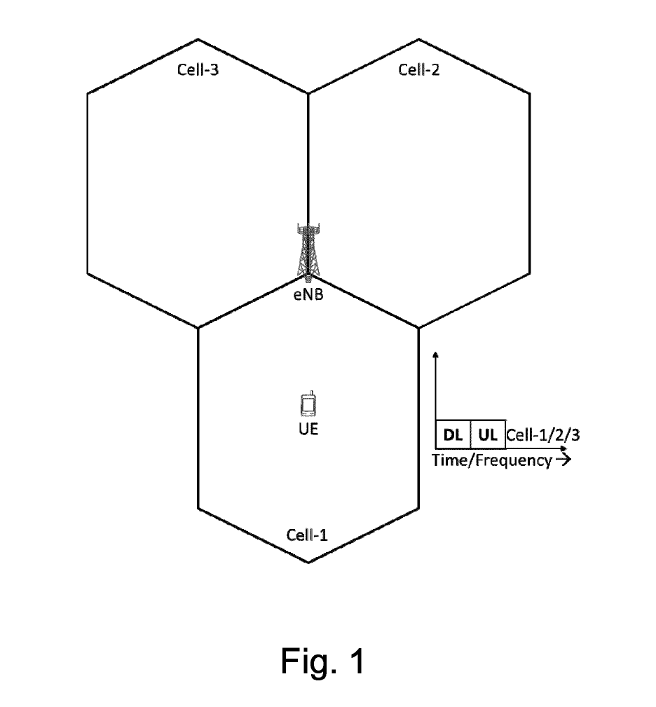

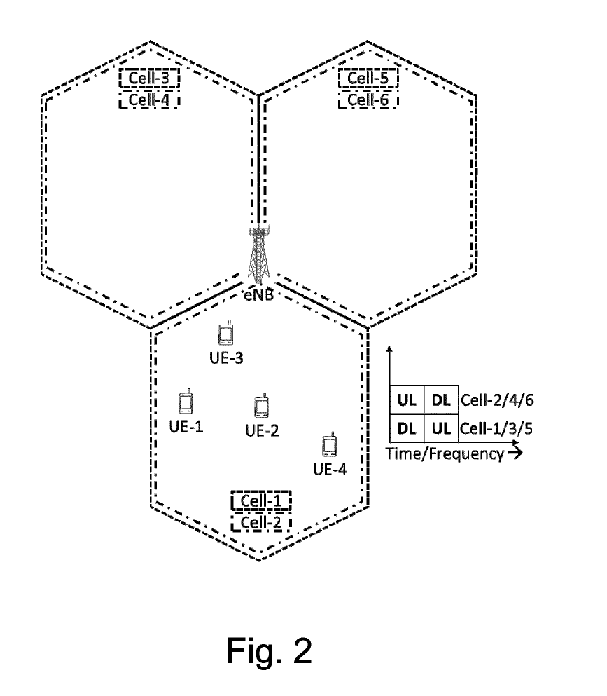

The conventional three sector/cell macro eNB is shown in FIG. 1, with time/frequency resources being used in a half duplex mode. The full duplex eNB in transparent mode could be envisioned as shown in FIG. 2, with each cell being split into two virtual cells from the UE perspective. The eNB can then group UEs within its coverage area according to the criteria mentioned earlier. Even though the cell coverage footprint is shown as slightly different for each virtual cell, it is only for illustrative purposes alone and the coverage of each virtual cell would be the same, depending on real-time channel conditions.

One of the drawbacks of this approach could be the higher signaling involved in terms of virtual handover between cells as well as possible core network signaling impacts, which needs to be minimized. For instance, with this approach, the eNB for the same cell would have to send two different sets of control signals such as cell specific reference signals, as well as system information blocks, etc. causing sub-optimal performance within an actual cell. The data/user plane signaling with the core network could be avoided by using a “virtual” X2 handover between the virtual cells, within the same macro cell. Also, if core network features such as user location information (ULI) location specific charging, etc., see 3GPP TS 23.271, “Functional stage 2 description of Location Services (LCS)”, are used, eNB would have to report to the charging functions in the core network each time UE changes the virtual cell. This would lead to additional, e.g., control plane, signaling, which could be avoided in non-transparent mode. Apart from the minimal standardization requirements involved, currently defined eICIC mechanisms could be applied for mitigating interference between simultaneous UL/DL operations of a macro-cell, i.e. between virtual cells.

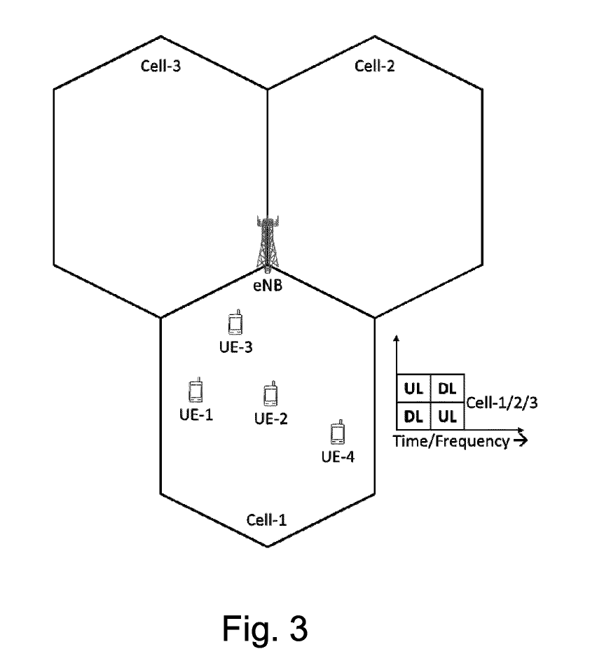

In the non-transparent mode of operation, the full duplex operation is provided in a non-transparent manner to the UE, meaning that UE is aware of the fact that there are full duplex transmissions from its serving cell. This method would require more standardization effort for provisioning services to the UE in an efficient manner. The main advantage of this approach would be that there is less control signaling and virtual handover related core network signaling involved. The possible operation is as shown in FIG. 3, with each cell having both UL and DL in the same time/frequency resources or physical resource blocks. This would also mean that UE could estimate the channel conditions inaccurately due to intra-cell interference from its own serving cell transmissions. For overcoming this, the eNB can configure static resources which will be used by UEs for measuring the quality of the channel. The static resources could be reserved resource blocks within a subframe, and this information needs to be signaled to the UE. The signaling could be done dynamically if the measurement resources vary over time, depending on the cell load, etc. Alternately, this could be done in a static manner using system information blocks. Thus, the UE is aware of the measurement resource configurations provisioned by the eNB.

The non-transparent mode can also be operated in using the intra-eNB, intra-cell carrier aggregation mechanism with the simultaneous UL/DL modes assumed to be two different carriers from UE perspective. Using full duplex base stations or eNBs, the same carrier can be used for UL and DL. This means that, in an FDD system with separate carriers for UL and DL like in conventional systems, the half duplex mobile device or UE could be configured to view the system as one employing carrier aggregation technique, with UL and DL resources scheduled in different carriers, but with a common carrier for control channel signaling. Using such a mechanism, the system would emulate carrier aggregation from mobile device's or UE's perspective, but operating in a full duplex mode from an overall system perspective. The system will use one carrier for control signalling and then two configurations: a) carrier aggregation with carrier 1 for UL and carrier 2 for DL, and b) carrier aggregation with carrier 2 for UL and carrier 1 for DL.

### Measurement Configuration for Transparent Mode:

For transparent mode, since frequent and fast handover would be required, accurate measurement configurations by the mobile device or UE are important. But, since the virtual cells involved here are part of the same macro cell, separate measurement configurations might not be required. But this would also depend on the power control algorithms the eNB might employ for inter-virtual-cell interference mitigation both on control as well as data/shared channels. This would mean that if DL power control is used, the macro eNB should send the measurement configurations via Radio Resource Control (RRC) signaling to the UE. Whereas, if power control is not used, macro eNB need not send any measurement configurations other than the ones based on normal neighbor relations used in the half duplex scenario.

### Handover Optimization for Transparent Mode:

Optimizations in terms of handover needs to be done in transparent mode, in both control and user plane. In user plane, X2 handover is assumed to be done in a virtual mode, such that eNB handles the routing of the data to the proper virtual cell and the information is not updated in the Mobility Management Entity (MME) context unless the overlaying macro cell information is changed. This could be done for instance by using virtual cell concept only in the lower ID layer, and using same Cell Global Identity, while using different Physical Cell IDs, PCI, see 3GPP TS 36.423, “Evolved Universal Terrestrial Radio Access Network (E-UTRAN); X2 Application Protocol (X2AP)”. Since using such a mechanism essentially hides the cell change from the core network, this would require new mechanisms for deriving the CGIs, compared to ones defined currently. Also, since this leads to a higher number of PCI reuse, conflict of PCIs between neighboring cells should be avoided.

### Intra-Cell Interference Coordination in Non-Transparent Mode:

In non-transparent mode, there could be high interference on the control channels due to simultaneous UL/DL operation. This could be avoided using almost blank subframe concept, see 3GPP TS 36.300, “Evolved Universal Terrestrial Radio Access (E-UTRA) and Evolved Universal Terrestrial Radio Access Network (E-UTRAN); Overall description; Stage 2”, whereby interfering subframes are muted by the eNB depending on the channel conditions of the victim UE. If the UL signal of the victim UE is getting drowned due to simultaneous DL transmissions from the eNB, the eNB should mute the downlink subframes for the duration during which UL UE, Uplink-UE, experiences severe interference. The vice versa is applicable if the victim UE is in DL and neighboring UL UE is drowning the DL signals from the eNB. Power control techniques could also be used to mitigate such interference. The key factor here is identifying the interference source as well as estimating the accurate link quality excluding intra-cell interference. For this purpose, static subframes or resources are proposed to be used, which gives an accurate estimate of the link quality that would be experienced by the UE without having intra-cell interference. This would also help eNB in determining the modulation and coding scheme that needs to be used both in UL and DL direction.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for operating a wireless network, wherein a base station is provided for data communication in uplink (UL) and downlink (DL) directions with at least one mobile device, the method comprising:
operating the base station in a full duplex data communication mode during communication with the at least one mobile device.

2. The method according to claim 1, wherein the base station comprises at least two different virtual half duplex cells.

3. The method according to claim 2, wherein the two virtual half duplex cells are realized or defined within one full duplex cell of the base station.

4. The method according to claim 2, wherein the two virtual half duplex cells have different Physical Cell IDs (PCIs) but have the same Cell Global Identity (CGI).

5. The method according to claim 2 4, wherein the at least one mobile device or each mobile device is allocated into or assigned to each virtual half duplex cell.

6. The method according to claim 2, wherein several mobile devices are grouped using at least one of a geographical location or a channel condition.

7. The method according to claim 2, wherein the base station sends different signaling information or two different physical layer control channels and/or associated signaling information for the same physical. full duplex cell to the at least one mobile device.

8. The method according to claim 2, wherein a handover of the at least one mobile device between the virtual half duplex cells is performed internally within the base station.

9. The method according to claim 2, wherein a handover of the at least one mobile device between the virtual half duplex cells is performed using an X2 handover procedure.

10. The method according to claim 2, wherein an enhanced. Inter-Cell Interference Coordination (eICIC), mechanism is applied for mitigating interference between simultaneous UL/DL operations between virtual half duplex cells.

11. The method according to claim 2, wherein the base station sends measurement configurations via Radio Resource Control (RRC) signaling to the at least one mobile device.

12. The method according to claim 1, wherein each cell of the base station provides both UL and DL in the same time or frequency resources or physical resource blocks.

13. The method according to claim 12, wherein the base station configures a static resource or static resources which is or are used by the at least one mobile device for measuring a quality of a channel.

14. The method according to claim 13, wherein the static resource or static resources is or arc in half duplex mode.

15. The method according to claim 13, wherein the static resource or static resources is or are reserved physical resource blocks within a subframe.

16. The method according to claim 15, wherein information about reserved resource blocks within a subframe is signaled to the at least one mobile device.

17. The method, according to claim 16, wherein the signaling is performed, if at least one definable characteristic of the static resource or static resources varies over a defined time interval by a defined amount or threshold.

18. The method according to claim 16, wherein the signaling is performed in a static manner using at least one system information block.

19. The method according to claim 12, wherein an intra-eNB, intra-cell carrier aggregation mechanism with simultaneous UL/DL modes assumed to be two different carriers from mobile device's perspective is used.

20. The method according to claim 19, wherein the same carrier is used for UL and DL.

21. The method according to claim 12, wherein almost blank subframe concept is used.

22. The method according to claim 12, wherein a power control technique is used to mitigate interference.

23. The method according to claim 1 wherein the base station is an eNode (eNB).

24. A wireless network for comprising,:
a base station for data communication in uplink (UL) and downlink (DL) directions with at least one mobile device,
wherein the base station is configured to operate in a full duplex data communication mode during communication with the at least one mobile device.

25. (canceled)
